(19) United States
(12) Patent Application Publication
(10) Pub. No.: US 2003/0217329 A1
(43) Pub. Date: Nov. 20, 2003

(54) Methods and apparatus for creating customized messages for printing on a transaction slip

(75) Inventor: Mark Good, Whitney Point, NY (US)

Correspondence Address: LAW OFFICE OF BARRY R LIPSITZ, 755 MAIN STREET, MONROE, CT, 06468, US

(73) Assignee: TransAct Technologies Incorporated, Wallingford, CT

(21) Appl. No.: 10/402,358

(22) Filed: Mar. 27, 2003

Related U.S. Application Data
(60) Provisional application No. 60/368,314, filed on Mar. 28, 2002.
(60) Provisional application No. 60/385,409, filed on Jun. 3, 2002.

(51) Int. Cl. G06F 15/00

(52) U.S. Cl. 715/500

(57) ABSTRACT

The present invention provides methods and apparatus for creating customized messages for printing on a transaction slip. A user interface is provided for creating a customized message for printing on the slip. At least one template for the message is provided. The template(s) corresponds to a layout of the transaction slip. A selection tool is enables the selection of a graphic from a menu of graphics files and inputting the graphic, if selected, into a graphic section of the at least one template. A header section of the at least one template is adapted to accept header text input for a message header. A text section of the at least one template is adapted to accept message text input for a message body. Each graphic file, header text and message text that has been input into respective sections of the at least one template are combined into a printable message.

This application claims the benefit of U.S. provisional patent application No. 60/368,314 filed on Mar. 28, 2002, which is incorporated herein and made a part hereof by reference. This application also claims the benefit of U.S. provisional application No. 60/385,409 filed on Jun. 3, 2002, which is incorporated herein and made a part hereof by reference.

### BACKGROUND OF THE INVENTION

The present invention relates generally to the field of printing. More specifically, the present invention relates to the creation of customized messages for printing on a transaction slip. The customized messages may include a combination of graphics, logos, text messages, transaction receipt information, and the like.

Point-of-sale transaction slips, such as a purchase receipt, an ATM receipt, a wagering voucher, a coupon, a ticket, or the like, provide a variety of advertising, promotional, and marketing opportunities. By including graphics, text, and logos on such a transaction slip, a retailer or other service provider may be able to reach a broader market segment with its advertising, promotions and marketing.

It would be advantageous to provide a simple and easy to use method for creating customized messages for printing on a transaction receipt. It would be further advantageous to provide an easy to use interface for creating such customized messages.

The methods and apparatus of the present invention provide the foregoing and other advantages.

### SUMMARY OF THE INVENTION

The present invention relates to methods and apparatus for creating customized messages for printing on a transaction slip. At least one template for the message is provided. The template(s) correspond to a layout of the transaction slip. A menu of graphic files is provided. One of the graphic files may be selected and input into a graphic section of the at least one template. Header text for a message header may be input into a header section of the at least one template. Message text for a message body may be inserted into a text section of the at least one template. Each graphic file, header text and message text that has been input into respective sections of the at least one template is then combined with the other such files and text into a printable message. The transaction slip containing the printable message may then be printed at a printing device.

The transaction slip may comprise at least one of a coupon, a ticket, a receipt, an advertisement, a voucher, or the like.

The transaction slip may be printed at a point of sale terminal.

A border character may be selected from a menu of border characters for a message border. The border character may be inserted into a border section of the at least one template when selected. The border may be included as part of the printable message. Border text for the border may be input into a border text section of the at least one template. The border text may be inserted into the border of the printable message. The border text may be input in at least one of an upper border section or a lower border section.

A printer command may be inserted into a barcode section of the at least one template to enable a printing device to print a barcode on the message.

A logo may be selected from a menu of logos and inserted into a logo section of the at least one template when selected. The logo may then be included as part of the printable message.

Receipt text for a receipt may be inserted into a receipt section of the at least one template. The receipt text may be inserted into the printable message.

The at least one template may comprise at least one of a promotional template, a receipt template, and a logo template. In an embodiment where the at least one template includes each of a promotional template, a receipt template, and a logo template, an order of printing of the template sections may be designated.

The printable message may be saved as a .prn file. The printable message may also be saved as a .prn file with an instruction to store the .prn file in memory at a printing device. The .prn file and instruction may be sent to the printing device, where the instruction may be executed and the .prn file may be stored at the printing device. The message may then be printed at the printing device when desired (e.g., each time a receipt is printed, each time a transaction occurs, etc.).

The present invention enables a selection of color from at least two printer colors for at least one of the text and graphics. The printable message may then be printed on a two-color printing device.

The size of the text section and/or the graphic section may be adjusted as desired.

Formatting options for the header text and the message text may be provided. The formatting options may comprise at least one of font size, draft font size, text justification left, text justification center, text justification right, bold, italic, underline, primary color, secondary color, and the like.

The present invention also enables text in the message to be treated as a printer command upon receipt of the message by a printing device.

A character count of a number of text characters in the printable message may be provided. In addition, a pixel count of a number of pixels contained in the graphic or a logo in the printable message may also be provided.

A print preview of the printable message may be generated before printing of the printable message.

### BRIEF DESCRIPTION OF THE DRAWINGS

The present invention will hereinafter be described in conjunction with the appended drawing figures, wherein like numerals denote like elements, and:

FIG. 1 shows an example embodiment of the invention implemented in a Windows based application program;

FIG. 2 shows an example of a graphics menu in accordance with an embodiment of the invention;

FIG. 3 shows a block diagram of an example embodiment of the invention;

FIG. 4 shows an example “promo” template in accordance with the invention;

FIG. 5 shows an example “logo and receipt” template in accordance with the invention;

FIG. 6a shows an example pop-up box used for selection of a logo in accordance with the invention;

FIG. 6b shows the example pop-up box of FIG. 6a when a graphics folder is opened;

FIG. 7 shows example commands provided in accordance with the invention;

FIG. 8 shows an example of a pop-up box used for determining character and pixel counts in accordance with the invention; and

FIG. 9 shows an example transaction slip printed in accordance with the invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

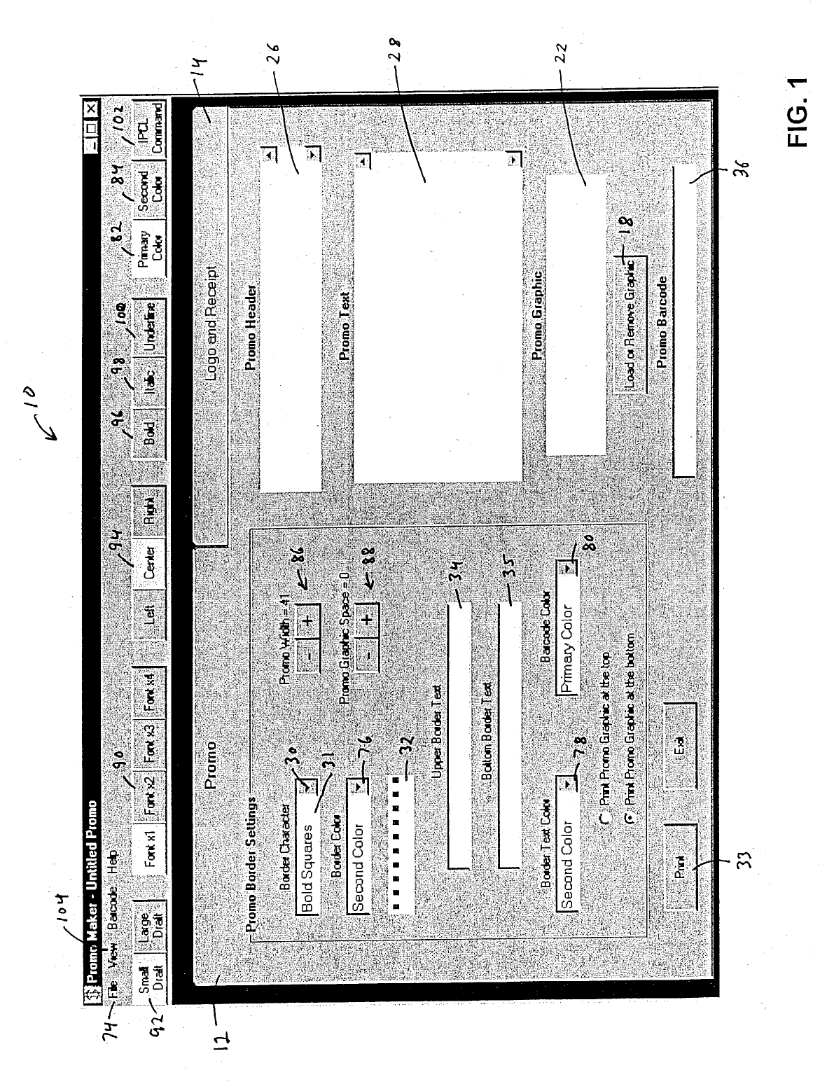

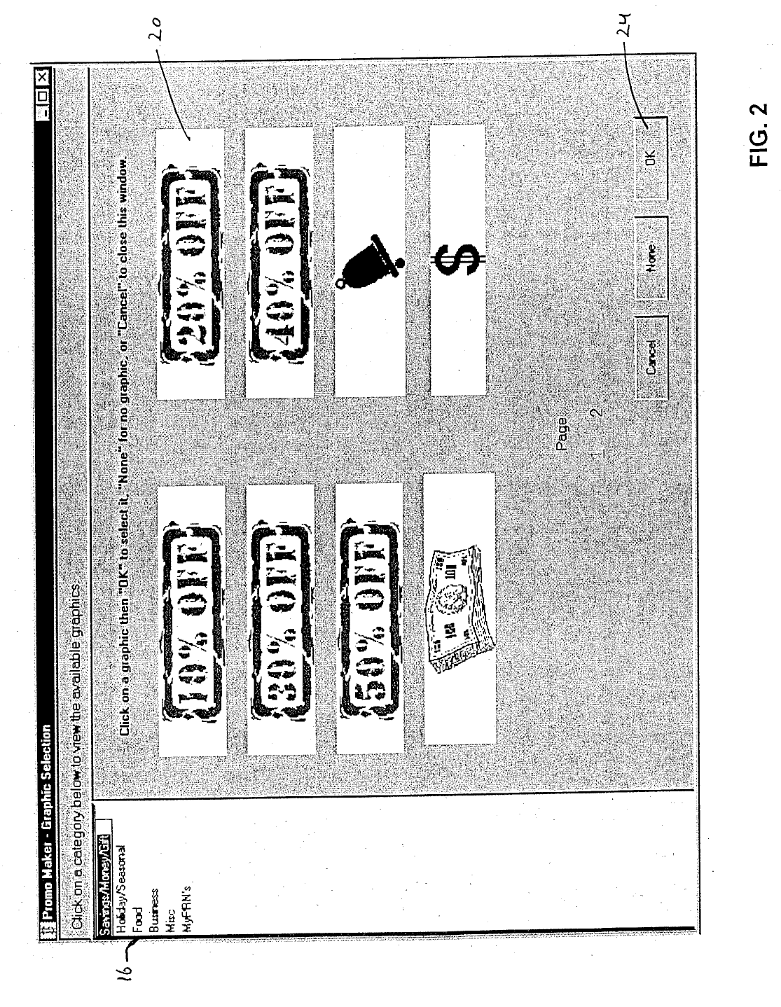

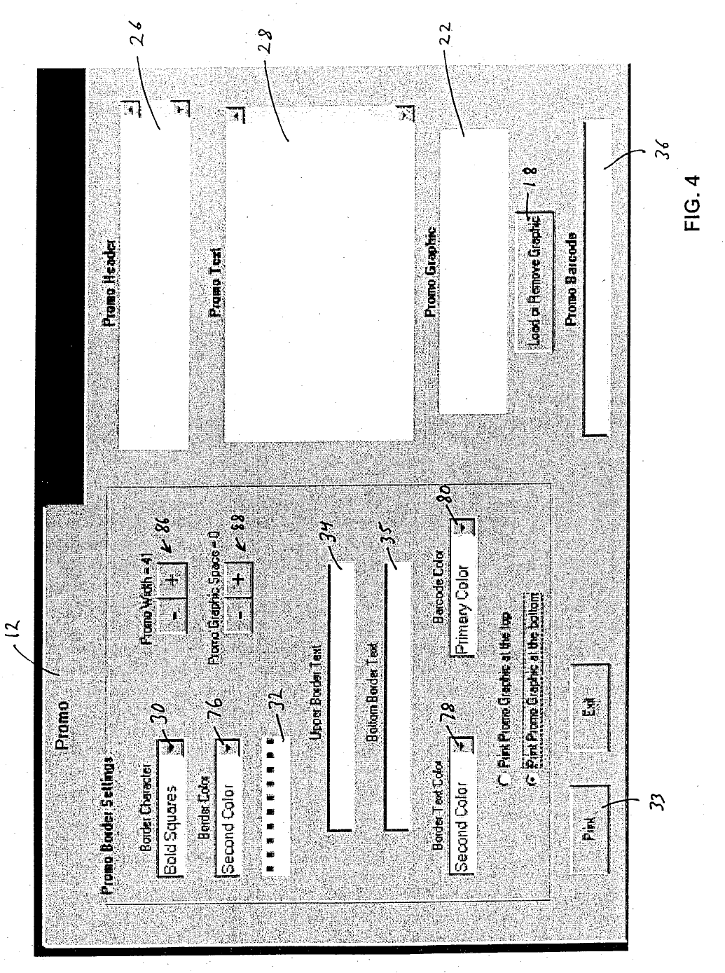

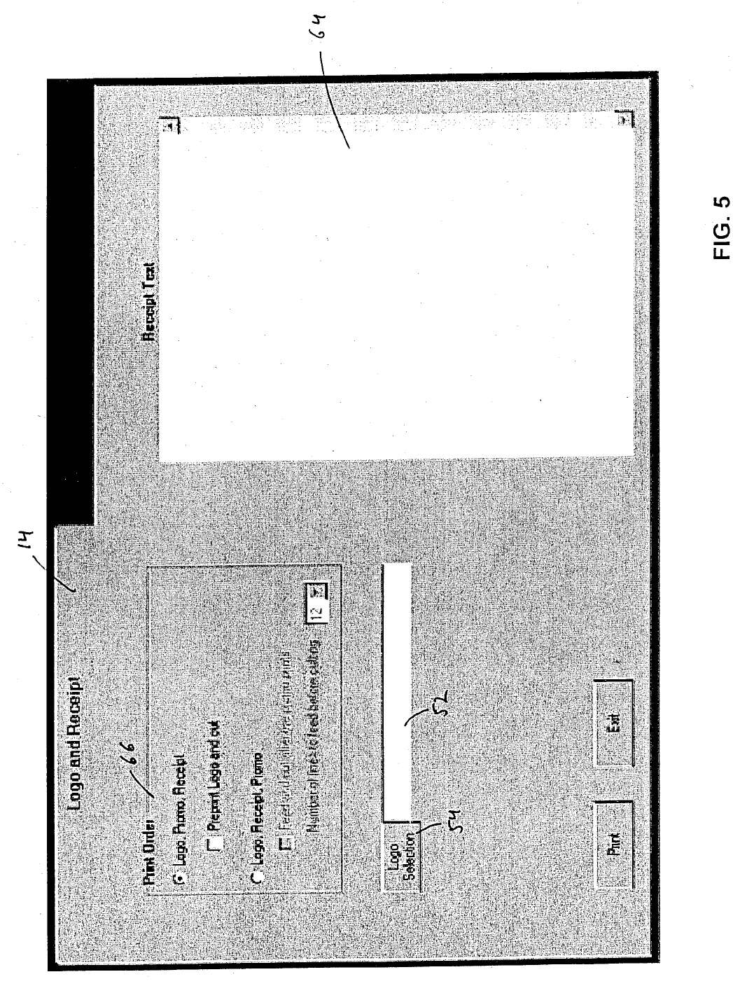

The present invention relates to methods and apparatus for creating customized messages for printing on a transaction slip. In an example embodiment of the invention as shown in FIGS. 1-8, a user interface 10 is provided for creating a customized message for printing on a transaction slip. At least one template (e.g., templates 12 and 14) for the message is provided as part of the user interface 10. Example templates 12 and 14 are shown separately in FIGS. 4 and 5, respectively. The template(s) corresponds to a layout of the transaction slip. A menu of graphic files 16 is also provided as shown in FIG. 2. For example, selecting the “Load or Remove Graphic” button 18 (FIG. 1) will bring up the menu 16 shown in FIG. 2. FIG. 2 shows an example of graphics provided under menu heading “Savings/Money/Gift.” A selection tool is provided for enabling the selection of a graphic 20 from the graphics files 16 and inputting the graphic 20, if selected, into a graphic section 22 of the at least one template (e.g., template 12 in the example shown). The selection tool may comprise a mouse in connection with a button (e.g., button 24). For example, to select a graphic 20, a user may position a mouse (or similar device) over the graphic 20 and click the mouse to select the graphic. The selected graphic 20 will then be highlighted. Clicking on the “OK” button 24 will cause the selected graphic 20 to be inserted into the graphic section 22 of the template 12. The programming of such a function will be apparent to those skilled in the art.

The user interface 10 further may further comprise a header section 26 of the at least one template 12 adapted to accept header text input for a message header. A text section 28 of the at least one template 12 is also provided and is adapted to accept message text input for a message body. Text may be inserted into the header section 26 or the text section 28 by, for example, positioning a mouse in the desired section 26 or 28. Clicking the mouse in such a position will result in a cursor appearing in that section. Text may then be typed into the section in a conventional manner using a keyboard or the like. Voice recognition software could also be used to provide the text inputs. Text may be entered, at the user's discretion, in either or both of header field 26 and text field 28. Likewise, the selection and entry of a graphic file into the graphic filed 22 is optional and at the user's discretion.

Means are provided for combining each graphic file, header text and message text that has been input into respective sections (e.g., graphic section 22, header section 26, and text section 28) of the at least one template into a printable message. For example, once the desired inputs have been made and/or selected for the corresponding template sections, a processor combines any template sections which contain such inputs into a printable message.

A print command 33 may be provided for printing the transaction slip containing the message. The processor may automatically combine the template information into the printable message upon receipt of the print command. The transaction slip may comprise at least one of a coupon, a ticket, a receipt, an advertisement, a voucher, or the like. The transaction slip may be printed, for example, at a point of sale terminal such as a cash register, a lottery terminal, a slot machine or other wagering terminal, a ticket machine (e.g., train, bus or airplane tickets), etc. The printer used in the terminal can comprise any type of suitable printer known in the art, such as an inkjet printer, thermal printer, or dot-matrix printer. Examples of such printers are the various inkjet, thermal and impact printers manufactured by TransAct Technologies Incorporated of Ithaca, N.Y., USA.

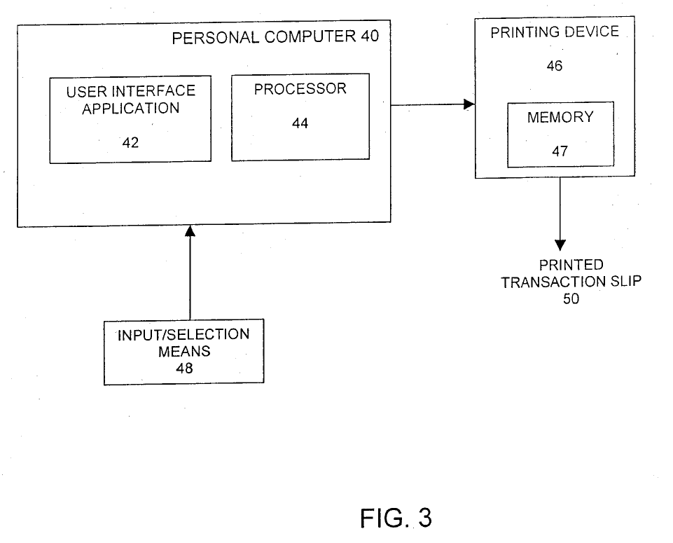

A high-level block diagram of an example embodiment of the present invention is shown in FIG. 3. Those skilled in the art should appreciate that the present invention may be implemented in a variety of ways, including differing combinations of software, hardware and firmware, and that the example embodiment illustrated in FIG. 3 is provided for ease of explanation only. FIG. 3 shows the present invention as implemented on a personal computer 40 having a user interface application 42 and a processor 44. The user interface application 42 may be a software application that generates the user interface 10 shown in FIG. 1. A user may provide inputs to the user interface application 42 via conventional input/selection means 48 (e.g., a mouse and keyboard or the like). The processor 44 executes the user interface application 42 on the personal computer 40 and combines the templates into the printable message as discussed above. The processor 44 forwards the printable message to the printing device 46 upon receipt of the print command. The printing device 46 then prints the transaction slip 50 containing the printable message. Local memory 47 is provided at the printer to store the printable message pending printing, and to provide the ability to store one or more selected graphics and standard messages so such items do not have to be repeatedly sent from the personal computer 40 to the printing device.

The user interface 10 may also include a menu of border characters (e.g., drop down menu 30) for a message border and a border section 32 of the at least one template. In such an embodiment, the selection tool enables the selection of a border character 31 from the menu of border characters 30 and inputs the border character 31 into the border section 32 when selected. In the example shown in FIG. 1, the border character 31 selected from the drop down menu 30 is “bold squares”, resulting in solid squares being input into the border section 32. Those skilled in the art will appreciate that a wide variety of border characters 31 may be provided, including, for example, squares, dollar signs, asterisks, question marks, number signs, ampersands, or other symbols or designs. The combining means (e.g., processor 44) enables the inclusion of the border as part of the printable message.

A border text section (e.g., upper and lower border text sections 34 and 35) of the at least one template may also be provided which is adapted to accept border text for the border. The combining means enables insertion of the border text into the border of the printable message. The border section may comprise at least one of an upper border section 34 or a lower border section 35 and border text may be inserted in the upper section, the lower section, or both sections.

The interface 10 may also include a barcode section 36 of the at least one template to enable a printing device to print a barcode on the message in accordance with a printer command inserted in the barcode section 36.

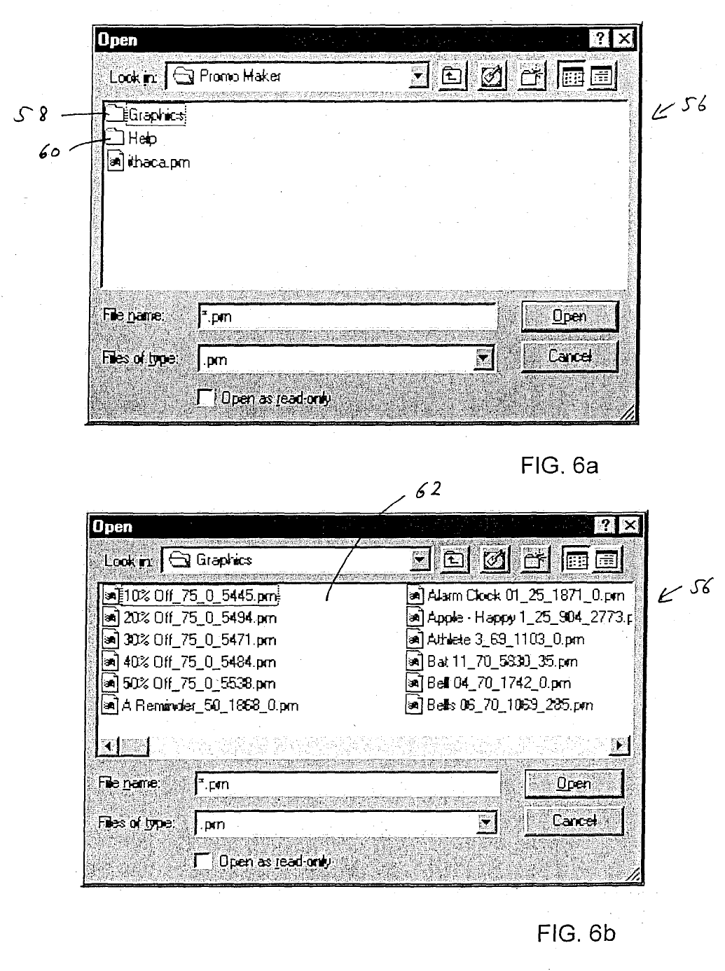

As shown in FIGS. 5-6, a menu of logos for use on the message may also be provided. A logo section 52 of the at least one template may be provided for identifying the logo to be included on the transaction slip. The logo may be, for example, a corporate logo, a graphic, or the like. In the example shown, the logo section 52 is provided in template 14 which is shown in detail in FIG. 5. The selection tool enables the selection of a logo from the logo menu and inserts a logo identifier (e.g., file name) into the logo section 52 when selected. For example, a mouse may be used to click on the “Logo Selection” button 54, which will cause a pop-up box 56 to appear as shown in FIG. 6a. The pop-up box 56 provides a graphics file 58 and a help file 60. Opening the graphics file 58 causes a plurality of logos 62 to appear in the pop-up box 56, as shown in FIG. 6b. The combining means enables inclusion of the logo as part of the printable message.

The interface 10 may also include a receipt section 64 of the at least one template 14 adapted to accept text for a receipt to appear on the message. The combining means enables insertion of the receipt text into the printable message.

The at least one template comprises at least one of a promotional template (e.g., template 12 shown in FIG. 4, a receipt template, and a logo template (e.g., logo and receipt template 14 shown in FIG. 5). In an embodiment where the at least one template comprises each of a promotional template, a receipt template, and a logo template, a print order command 66 may be provided for designating an order of printing of the template sections.

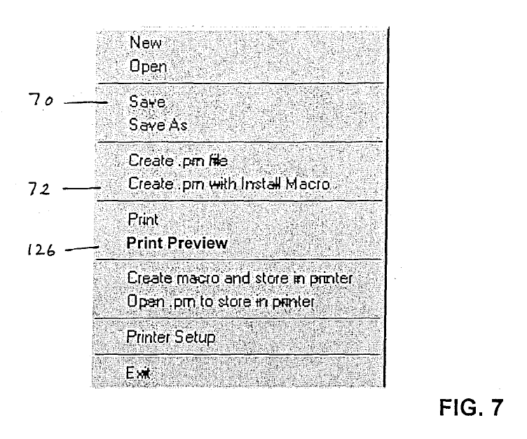

As shown in FIG. 7, a first save command 70 may be provided for saving the printable message as a .prn file. A second save command (e.g., create .prn file with install macro 72) may be provided for saving the printable message as a .prn file with an instruction to store the .prn file in memory 47 at a printing device 46 (see, e.g., FIG. 3). The .prn file and instruction may be sent to the printing device where the instruction may be executed such that the .prn file is stored at the printing device 46. The message may then be printed at the printing device 46 (e.g., at a predetermined time, upon request in response to a command input to the printing device, upon the satisfaction of certain conditions, after a transaction, or the like). The first and second save commands (along with various other commands as shown in FIG. 7) may be provided under the “file” button 74 as shown in FIG. 1.

The user interface 10 may include a color menu for enabling a selection of a color from at least two printer colors for at least one of the text and graphics. For example, a border color may be selected from drop down menu 76, a border text color may be selected from drop down menu 78, and/or a barcode color may be selected from drop down menu 80. The color of any input text (i.e., any text input into sections 26, 28, or 64 may be changed using primary color button 82 and secondary color button 84. The printable message may then be printed on a two-color printing device, such as a two-color inkjet printer. Those skilled in the art will appreciate that the present invention may easily be adapted to accommodate multiple colors for use with a full color printing device.

A first size selector 86 may be provided enabling adjustment of a size of the text section of the template. A second size selector 88 may be provided enabling adjustment of a size of the graphic section of the template. For example, by clicking on the + or − of the first size selector 86, the size of the text section 28 may be incrementally increased or decreased to fit, as desired, on a transaction slip. By clicking on the + or − of the second size selector 88, the size of the graphics section 22 may be incrementally increased or decreased.

Text formatting options may also be provided for the header text and the message text. The formatting options may comprise at least one of font size 90, draft font size 92 (i.e. the size of the text font for printing a draft version of the message), text justification 94 (i.e. left, center, or right), bold 96, italic 98, underline 100, primary color 82, and secondary color 84.

A printer control language command 102 may be provided enabling text in the message to be treated as a printer command upon receipt of the message by a printing device. The printer control language command 102 may comprise, e.g., a PCL command or an IPCL (Ithaca Printer Control Language) command. Such commands are well known in the art.

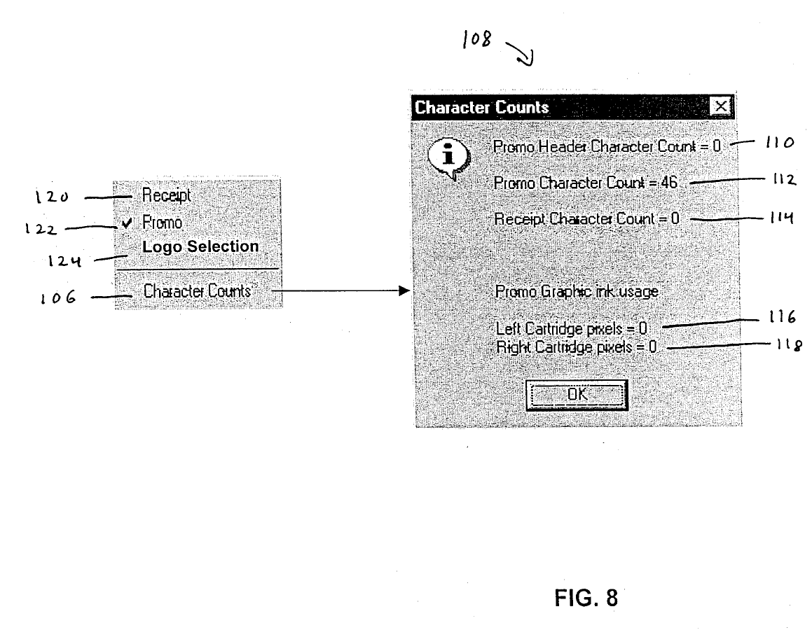

The interface 10 may also include a character count tool for providing a character count of a number of text characters in the printable message. A pixel count tool for providing a pixel count of a number of pixels contained in the graphic or a logo in the printable message may also be included as part of the interface 10. For example, as shown in FIG. 8, a character counts command 106 may be provided under the view button 104 (FIG. 1). Selection of the character counts command 106 results in a pop-up box 108 which indicates the character count of the various text sections, including header text character count 110, message text character count 112, and receipt text character count 114. A pixel count for the graphics and logo may be divided into a pixel count for each color to be printed (e.g., left cartridge pixel count 116 and right cartridge pixel count 118 where the left and right cartridges hold different color inks).

As shown in FIG. 8, the view button 104 also enables a user to select one or all of the templates provided for use in creating the message on the transaction slip. For example, a receipt template may be selected using the receipt button 120, a promotional template may be selected using the promo button 122, and a logo template may be selected using the logo button 124.

A print preview command 126 may be provided for generating a print preview of the printable message (see, e.g., FIG. 7).

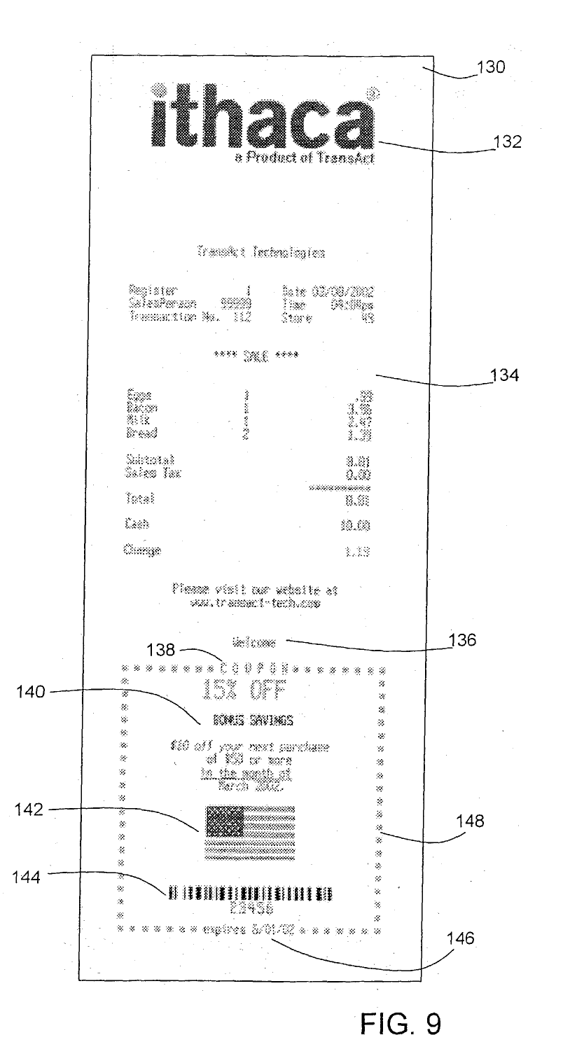

FIG. 9 illustrates an example transaction slip 130 printed in accordance with the invention. The logo selected by the user is printed at 132. The Receipt Text is printed at 134. The Promo Header “Welcome” is shown at 136. The Border 148 includes Upper Border Text 138 (“COUPON”) and Bottom Border Text 146 (“expires Jun. 6, 2002,”). The Promo Text 140 and Promo Graphic 142 are positioned within the coupon border 148, as is the Promo Barcode 144. It should be appreciated that the layout shown in FIG. 9 is for example purposes only, and that other layouts of text and graphics can be generated on the transaction slip in accordance with the invention.

The invention also encompasses methods for creating a customized message for printing on a transaction slip, which correspond to the user interface described above.

It should now be appreciated that the present invention provides advantageous methods, systems and software for creating customized messages for printing on a transaction slip.

Although the invention has been described in connection with various illustrated embodiments, numerous modifications and adaptations may be made thereto without departing from the spirit and scope of the invention as set forth in the claims.

What is claimed is:

1. A method for creating a customized message for printing on a transaction slip, comprising:
providing at least one template for said message, said template corresponding to a layout of said transaction slip;
providing a menu of graphic files;
enabling the selection and input of one of said graphic files into a graphic section of said at least one template;
enabling the input of header text for a message header into a header section of said at least one template;
enabling the input of message text for a message body into a text section of said at least one template; and
combining each graphic file, header text and message text that has been input into respective sections of the at least one template into a printable message.

2. A method in accordance with claim 1, further comprising printing said transaction slip containing said message.

3. A method in accordance with claim 2, wherein said transaction slip comprises at least one of a coupon, a ticket, a receipt, an advertisement, and a voucher.

4. A method in accordance with claim 2, wherein said transaction slip is printed at a point of sale terminal.

5. A method in accordance with claim 1, further comprising:
enabling the selection of a border character from a menu of border characters for a message border; and
inserting said border character into a border section of said at least one template when selected; wherein
said combining step further comprises including said border as part of said printable message.

6. A method in accordance with claim 5, further comprising:
enabling the input of border text for said border in a border text section of said at least one template;
wherein said combining step further comprises inserting said border text into said border of said printable message.

7. A method in accordance with claim 6, wherein said border text is enabled to be input in at least one of an upper border section or a lower border section.

8. A method in accordance with claim 1, further comprising:
inserting a printer command in a barcode section of said at least one template to enable a printer to print a barcode on said message.

9. A method in accordance with claim 1, further comprising:
enabling the selection of a logo from a menu of logos; and
inserting said logo into a logo section of said at least one template when selected;
wherein said combining step further comprises including said logo as part of said printable message.

10. A method in accordance with claim 1, further comprising:
inserting receipt text for a receipt in a receipt section of said at least one template;
wherein said combining step further comprises inserting said receipt text into said printable message.

11. A method in accordance with claim 1, wherein;
said at least one template comprises at least one of a promotional template, a receipt template, and a logo template.

12. A method in accordance with claim 1, wherein said at least one template comprises a promotional template, a receipt template, and a logo template, further comprising:
designating an order of printing of said template sections.

13. A method in accordance with claim 1, further comprising:
saving said printable message as a .prn file.

14. A method in accordance with claim 1, further comprising:
saving said printable message as a .prn file with an instruction to store said .prn file in memory at a printing device.

15. A method in accordance with claim 14, further comprising:
sending said .prn file and instruction to said printing device; and
storing said .prn file at said printing device.

16. A message in accordance with claim 15, further comprising printing said message at said printing device.

17. A method in accordance with claim 16, further comprising:
enabling a selection of color from at least two printer colors for at least one of the text and graphics.

18. A method in accordance with claim 1, further comprising:
enabling adjustment of a size of the text section.

19. A method in accordance with claim 1, further comprising:
enabling adjustment of a size of said graphic section.

20. A method in accordance with claim 1, further comprising:
providing text formatting options for said header text and said message text, said formatting options comprising at least one of font size, draft font size, text justification left, text justification center, text justification right, bold, italic, underline, primary color, and secondary color.

21. A method in accordance with claim 1, further comprising:
enabling text in said message to be treated as a printer command upon receipt of the message by a printing device.

22. A method in accordance with claim 1, further comprising:
providing a character count of a number of text characters in said printable message.

23. A method in accordance with claim 1, further comprising:
providing a pixel count of a number of pixels contained in said graphic or a logo in said printable message.

24. A method in accordance with claim 1, further comprising:
generating a print preview of said printable message.

25. A user interface for creating a customized message for printing on a transaction slip, comprising:
at least one template for said message, said template corresponding to a layout of said transaction slip;
a menu of graphic files;
a selection tool for enabling the selection of a graphic from said graphics files and inputting the graphic, if selected, into a graphic section of said at least one template;
a header section of said at least one template adapted to accept header text input for a message header;
a text section of said at least one template adapted to accept message text input for a message body; and
means for combining each graphic file, header text and message text that has been input into respective sections of the at least one template into a printable message.

26. An interface in accordance with claim 25, further comprising:
a print command for printing said transaction slip containing said message.

27. An interface in accordance with claim 26, wherein said transaction slip comprises at least one of a coupon, a ticket, a receipt, an advertisement, and a voucher.

28. An interface in accordance with claim 26, wherein said transaction slip is printed at a point of sale terminal.

29. An interface in accordance with claim 25, further comprising:
a menu of border characters for a message border; and
a border section of said at least one template; wherein
said selection tool enables the selection of a border character from said menu of border characters and inputs said border character into said border section when selected; and
said combining means enables the inclusion of said border as part of said printable message.

30. An interface in accordance with claim 29, further comprising:
a border text section of said at least one template adapted to accept border text for said border;
wherein said combining means enables insertion of said border text into said border of said printable message.

31. An interface in accordance with claim 30, wherein said border section comprises at least one of an upper border section or a lower border section.

32. An interface in accordance with claim 25, further comprising:
a barcode section of said at least one template to enable a printer to print a barcode on said message in accordance with a printer command inserted in said barcode section.

33. An interface in accordance with claim 25, further comprising:
a menu of logos for use on said message; and
a logo section of said at least one template; wherein
said selection tool enables the selection of a logo from the logo menu and inserts said logo into said logo section when selected; and
said combining means enables inclusion of said logo as part of said printable message.

34. An interface in accordance with claim 25, further comprising:
a receipt section of said at least one template adapted to accept receipt text for a receipt to appear on said message;
wherein said combining means enables insertion of said receipt text into said printable message.

35. An interface in accordance with claim 25, wherein;
said at least one template comprises at least one of a promotional template, a receipt template, and a logo template.

36. An interface in accordance with claim 25, wherein said at least one template comprises a promotional template, a receipt template, and a logo template, further comprising:
a print order command for designating an order of printing of said template sections.

37. An interface in accordance with claim 25, further comprising:
a first save command for saving said printable message as a .prn file.

38. An interface in accordance with claim 25, further comprising:
a second save command for saving said printable message as a .prn file with an instruction to store said .prn file in memory at a printing device.

39. An interface in accordance with claim 38, wherein:
said .prn file and instruction are sent to said printing device; and
said .prn file is stored at said printing device.

40. An interface in accordance with claim 39, wherein said message is printed at said printing device.

41. An interface in accordance with claim 40, further comprising:
a color menu for enabling a selection of a color from at least two printer colors for at least one of the text and graphics.

42. An interface in accordance with claim 25, further comprising:
a first size selector enabling adjustment of a size of the text section.

43. An interface in accordance with claim 25, further comprising:
a second size selector enabling adjustment of a size of said graphic section.

44. An interface in accordance with claim 25, further comprising:
text formatting options for said header text and said message text, said formatting options comprising at least one of font size, draft font size, text justification left, text justification center, text justification right, bold, italic, underline, primary color, and secondary color.

45. An interface in accordance with claim 25, further comprising:
a printer control language command enabling text in said message to be treated as a printer command upon receipt of the message by a printing device.

46. An interface in accordance with claim 25, further comprising:
a character count tool for providing a character count of a number of text characters in said printable message.

47. An interface in accordance with claim 25, further comprising:
a pixel count tool providing a pixel count of a number of pixels contained in said graphic or a logo in said printable message.

48. An interface in accordance with claim 25, further comprising:
a print preview command for generating a print preview of said printable message.
